(19) United States
(12) Patent Application Publication
(10) Pub. No.: US 2025/0385925 A1
(43) Pub. Date: Dec. 18, 2025

(54) ARRANGEMENT AND A METHOD OF THREAT PREVENTION IN A COMPUTER OR COMPUTER NETWORK

(71) Applicant: WithSecure Corporation, Helsinki (FI)

(72) Inventor: Jarno NIEMELÄ, Helsinki (FI)

(21) Appl. No.: 19/233,021

(22) Filed: Jun. 10, 2025

(30) Foreign Application Priority Data
Jun. 12, 2024 (GB) 2408382.6

(51) Int. Cl. H04L 9/40

(52) U.S. Cl. CPC H04L 63/1416

(57) ABSTRACT

A computer-implemented method, system, and computer-readable medium for threat detection in a computer or computer network are disclosed, comprising collecting DNS (Domain Name System) queries and/or information relating to DNS queries, identifying failed queries from the collected DNS queries and/or from information relating to DNS queries, and determining whether a domain related to the failed DNS query is related to an expired and/or unregistered domain, e.g. from a domain name related database.

### CROSS-REFERENCE TO RELATED APPLICATION

This application claims the benefit of and priority to United Kingdom (GB) Patent Application No. 2408382.6 filed Jun. 12, 2024, the contents of which being incorporated by reference in their entirety herein.

### TECHNICAL FIELD

The present disclosure relates to an arrangement and a method of threat prevention and/or threat detection in a computer or computer network.

### BACKGROUND

Security and threat detection systems for computers and computer networks are used to detect threats and anomalies in computers and computer networks. Examples of such are Endpoint Protection Platform (EPP), Endpoint Detection & Response (EDR) and Managed Detection and Response (MDR) products and services. An endpoint protection platform (EPP) is a solution deployed on endpoint devices to prevent file-based malware attacks and to detect malicious activity. Also, EDR systems focus on the detection and monitoring of a breach as it occurs and helps to determine how best to respond the detected breach. EDR systems also provide the investigation and remediation capabilities needed to respond to dynamic security incidents and alerts. MDR in turn is a managed cybersecurity service providing service for threat detection, response, and remediation.

Modern EDR and MDR services can rely on endpoint-side software agents or sensors that collect, preprocess and submit relevant state and behavioral data to the backend side whose data processing pipelines focus on advanced enrichment and analysis of the data for further timely attack detection and response. Increasing complexity and sophistication of advanced cyberattacks requires continuous development and maintenance of mechanisms from EDR and MDR service providers to be able to provide early detection of new and modified attack patterns.

In the recent years, vulnerability management systems have become more widely used. These systems primarily focus on identifying and addressing vulnerabilities within an organization's IT infrastructure, applications, and systems. Vulnerability management systems can for example systematically scan, assess, and prioritize vulnerabilities to determine which pose the greatest risk to the organization. Based on this information the vulnerability management system can, for example, patch existing vulnerabilities and thus reduce the attack surface by proactively identifying and mitigating vulnerabilities before they can be exploited by attackers. Risk management and evaluation can be taken further with Exposure Management systems which not only take care of analyzing vulnerabilities but also other factors that contribute to the organization's risk exposure, such as threat landscape, business impact, and effectiveness of security controls.

For establishing connections between devices in a computer network, such as internet, a Domain Name System (DNS) can be used. The Domain Name System (DNS) is a hierarchical and distributed name service that provides a naming system for computers, services, and other resources on the Internet or in other Internet Protocol (IP) networks. It associates various information with domain names (identification strings) assigned to each of the associated entities. It for example translates domain names to the numerical IP addresses needed for locating and identifying computer services and devices with the underlying network protocols.

Domain names have to be registered and the registration stays usually valid for a certain time period after which the registration expires unless renewed. Using, for example, links to unregistered or expired domains by the services or applications is a significant security risk. For example, if there are connections to a previously registered domain this is a significant security risk as very few client-software does server authentication and any reply from any server is often accepted by the client. Depending on the application that is connecting to an unregistered domain, it could open a way to do, for example, SSRF server-side request forgery, command injection, API key harvesting, NTLM hash grabbing or other client server connection abuse attacks.

The current cyber security and threat detection solutions are not able to recognize unregistered or expired domain addresses efficiently and reliably and therefore they are also not able to take required actions based on this information.

For these reasons there is a need for a reliable and efficient threat detection method, which is able to detect using of unregistered and/or expired domains and react to these.

### BRIEF SUMMARY

The following presents a simplified summary in order to provide basic understanding of some aspects of various embodiments. The summary is not an extensive overview of the disclosure. It is neither intended to identify key or critical elements of the invention nor to delineate the scope of the invention. The following summary merely presents some concepts of the disclosure in a simplified form as a prelude to a more detailed description of exemplifying embodiments of the disclosure.

According to a first aspect, the disclosure relates to a method, e.g., a computer implemented method, of threat detection in a computer or computer network, wherein the method comprises collecting DNS (Domain Name System) queries and/or information relating to DNS queries, identifying failed queries from the collected DNS queries and/or from information relating to DNS queries, and determining whether a domain related to the failed DNS query is related to an expired and/or unregistered domain, e.g., from a domain name related database.

In one embodiment of the disclosure, the DNS queries and/or information related to DNS queries are collected at the computer, for example, by an agent at the computer. In one embodiment of the disclosure, the DNS queries and/or information related to DNS queries are collected from domain reputation queries, such as EPP-domain reputation queries, event flow information, such as EDR- and MDR-event flow, DNS logs, such as device DNS logs and/or network device level DNS logs, and/or network level capture.

In one embodiment of the disclosure, if at least one expired and/or unregistered domain is found, the method further comprises generating an alert, such as a malware alert, and/or sending the alert, such as the malware alert, to a threat detection or prevention service, such as an attack surface mapping service, an EDR-service, an MDR-service, an exposure management services.

In one embodiment of the disclosure, the method further comprises identifying a process which has generated the call to the unregistered and/or expired domain, e.g., by an EDR- or MDR-service.

In one embodiment of the disclosure, the method further comprises determining past behavior of the identified process, e.g., based on telemetry history of an EDR- or MDR-service.

In one embodiment of the disclosure, the method further comprises monitoring the identified process by comparing the past behavior of the process to the current operation of the process, and if deviation between the past behavior and current behavior is observed, generating and/or sending an alert, e.g., an indicator of compromise-alert.

In one embodiment of the disclosure, the DNS queries relating to expired and/or unregistered domain, and/or the identified process which is generating calls to expired and/or unregistered domain is reported as an attack surface, e.g., to an attack surface mapping service or attack surface mapping system.

In one embodiment of the disclosure, information relating to the identified process which is generating calls to expired and/or unregistered domain, and/or a host, such as a computer, generating the identified call are used by an exposure management service when carrying out an attack path simulation, e.g., by simulating code execution by the identified process.

In one embodiment of the disclosure, an attack path simulation is configured to simulate a situation in which an attacker registers the domain and a DNS query to an expired and/or unregistered domain is directed to an attacker-controlled domain.

In one embodiment of the disclosure, the DNS queries relating to expired and/or unregistered domain, and/or the identified process which is generating calls to expired and/or unregistered domain are used at least in part for determining risk score for a host, such as a computer, risk score for an attack path on which the host is and/or risk score for the organization relating to the host, e.g., by increasing the risk score.

In one embodiment of the disclosure, the method further comprises automatically registering the expired and/or unregistered domain.

According to a second aspect, the disclosure relates to an arrangement for threat detection in a computer or computer network, wherein the arrangement comprises at least one computer. The arrangement is configured to collect DNS (Domain Name System) queries and/or information relating to DNS queries, to identify failed queries from the collected DNS queries and/or from information relating to DNS queries, and to determine whether a domain related to the failed DNS query is related to an expired and/or unregistered domain.

In one embodiment of the disclosure, the arrangement is configured to carry out a method according to any embodiment of the disclosure.

According to a third aspect, the disclosure relates to a computer program comprising instructions which, when executed by a computer, cause the computer to carry out a method according to the disclosure.

According to a fourth aspect, the disclosure relates to a computer-readable medium comprising the computer program according to the disclosure.

Unregistered or expired domains can be used for taking over hosts, such as computers and/or endpoints. The unregistered or expired domains can for example be used as backup C2 connections used by malicious actors whose implant is using domain generation algorithms, for SSRF server-side request forgery, command injection, API key harvesting, NTLM hash grabbing or other client server connection abuse attacks, etc. With the solution of the disclosure, using of unregistered or expired domain addresses can be recognized efficiently and reliably. Also required actions can be carried out so that the above-mentioned actions by the attackers or other malicious actors are not successful. In one embodiment of the disclosure, for example alerts can be given based on the findings and/or (optionally) in one embodiment of the disclosure the detected unregistered or expired domain can be automatically registered to prevent anyone else from registering it.

Various exemplifying and non-limiting embodiments of the disclosure both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the disclosure are illustrated by way of example, and not by way of limitation, in the figures of the accompanying drawings.

FIG. 1 presents as a schematic diagram a computer system or computer network configuration, for which exemplifying embodiments of the present disclosure are applicable.

FIG. 2 presents schematically an example network architecture of one embodiment of the disclosure.

FIG. 3 presents an example method according to one embodiment of the disclosure.

FIG. 4 presents as a schematic diagram an example structure of an arrangement according to an embodiment of the present disclosure.

### DETAILED DESCRIPTION

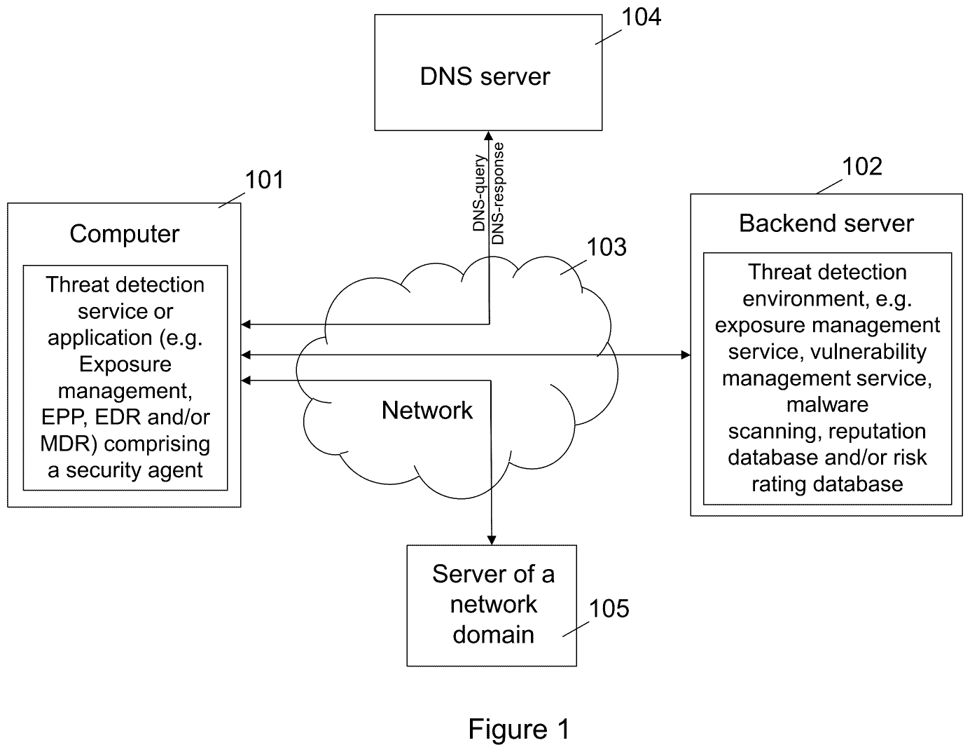

FIG. 1 presents an example environment in which the solution of the disclosure can be used. In the solution of FIG. 1 a system configuration is presented in which a computer 101, such as a local host and/or an endpoint, and a remote entity or server 102 are connected via a network 103. Here, the computer 101 exemplifies any computer or communication system, including a single device, a network node or a combination of devices, on which malware scanning or collection of threat detection related information is to be performed. The scanning and/or analysis of the threat detection related data can be done at the computer, endpoint and/or at the server. For example, the computer 101 may include an endpoint, a personal computer, a personal communication device, a network-enabled device, a client, a firewall, a mail server, a proxy server, a database server, or the like. The server 102 exemplifies any computer or communication system, including a single device, a network node or a combination of devices, on which malware scanning or threat detection data analysis can be performed for the computer 101 (such as an endpoint) or which can provide data for the computer 101 (such as an endpoint) required to carry out required operations, e.g., malware scanning, threat detection related analysis, such as risk rating, reputation data and/or attack path verification (e.g., for attack path mapping). For example, the server 102 may include a security entity or a backend entity of a security provider, or the like, and the server 102 may be realized in a cloud implementation or the like.

According to exemplifying embodiments of the disclosure, malware scanning and/or threat detection data analysis at the computer 101 and/or by the server 102 can be realized using a malware analysis environment, such as a virtual machine or emulator environment, arranged at the host and/or at the server. For example, an agent or sensor, such as, for example, an anti-virus software can be installed/arranged at the computer 101 to be used for attack path verification (e.g., for attack path mapping), collecting information relating to DNS-queries, malware scanning and/or threat detection data analysis. In one embodiment of the disclosure a sensor or agent at the computer is used to allow to intercept a file, a system configuration value and/or network operations called by the application. The sensor can be used to observe operation of the device, such as a computer, and information collected by the sensor can be used to detect malicious behavior of an application, a file and/or a process.

In one embodiment of the disclosure the malware scanning environment, service and/or software can detect starting and closing of applications, all unusual processes and attach monitoring to the required applications and processes. Also, when the services are started early, the service is able to detect and follow most of user's application. In one embodiment of the disclosure, when the malware scanning software or service is started up, it can perform running application inventory.

A threat detection network according to one embodiment of the disclosure may comprise at least one node, such as a network node and/or a computer, and at least one backend server. In this case information, e.g., threat detection models and/or model of normal behavior of an application, can be shared between the nodes and/or between the nodes and the backend server. In one embodiment of the disclosure the threat detection network can comprise only a plurality of nodes and no backend server is necessary. In this case information, e.g., threat detection models, can be shared between the nodes.

The network 103 exemplifies any computer or communication network, including, for example, a (wired or wireless) local area network like LAN, WLAN, Ethernet, or the like, a (wired or wireless) wide area network like WiMAX, GSM, UMTS, LTE, or the like, and so on. Hence, the computer 101 and the server 102 can but do not need to be located at different locations. For example, the network 103 may be any kind of TCP/IP-based network. Insofar, communication between the computer 101 and the server 102 over the network 103 can be realized using for example any standard or proprietary protocol carried over TCP/IP, and in such protocol the agent at the host 101 and the malware analysis sandbox or application at the server 102 can be represented on/as the application layer.

For establishing connections between devices, for example between servers 102, 105 and client computer 101, a Domain Name System (DNS) can be used. The Domain Name System (DNS) is a hierarchical and distributed name service that provides a naming system for computers, services, and other resources on the Internet or in other Internet Protocol (IP) networks. It associates various information with domain names (identification strings) assigned to each of the associated entities. It for example translates domain names to the numerical IP addresses needed for locating and identifying computer services and devices with the underlying network protocols.

When a computer wants for example to access a certain site, it can request information relating to the IP-address of the site from a DNS-server 104. In some examples the computer can first check browser and local DNS-cache and/or DNS-cache of a router to check if there's information relating to an IP address mapped to the domain the computer wants to access. If no such information is found, the information can be queried from a DNS-server 104, such as a DNS-server of an Internet Service Provider or a root name server. As a response to a query an authoritative name server responds with a response comprising an IP address mapped to the domain name. The IP address can then be forwarded to, for example, the browser and the browser can open for example a TCP/IP connection to the IP address, which is the address of the server 105 hosting of the certain network domain, and then send for example a HTTP-request. If the server 105 is up and running, it sends back HTTP responses to the browser. This way the computer 101 is able to connect to the server 105 of a certain network domain based on the received information comprising the IP-address of the server.

In one example, at the computer side, e.g., client computer side, of the DNS can be called a DNS resolver. The resolver can be responsible for initiating and sequencing the queries that ultimately lead to a full resolution (translation) of the resource sought, e.g., translation of a domain name into an IP address. DNS resolvers can be for example recursive, non-recursive, and/or iterative, and a resolution process may use a combination of these methods. The DNS resolver can collect information for the applications which are making DNS-queries. In one embodiment of the disclosure the solution of the disclosure this collected information can be used to detect failed DNS-queries.

In one embodiment of the disclosure the information relating to DNS queriers, and, for example, which applications is making a certain DNS query, can be collected and/or provided by the operating system of the computer and/or a DNS-query viewing or listing application and/or endpoint-side software agents or sensors. The operating system and/or a DNS-query viewing or listing application and/or endpoint-side software agents or sensors can collect and/or provide at least one of the following information: list of applications making DNS queries, process ID of the application making the DNS query, thread ID of the application making the DNS query, process name of the application making the DNS query, host name of the DNS-query, success of the DNS query (e.g., successful or failed). With this information the solution is able to know, for example, which applications and/or processes have been making failed DNS queries.

In one embodiment of the disclosure applications and/or processes which are known to be clean and/or not being malware, can be monitored, and it can be recognized when these applications and/or processes make a failed query, and then it can be determined whether a domain related to these failed DNS queries are related to an expired and/or unregistered domain. This way it can be ensured that an attacker can't utilize an expired domain which the application and/or process is trusting by registering the expired domain by the attacker.

A right to use a certain domain name is enabled by registering the domain name to the relevant authority. Registrant information associated with domain names is maintained in an online database accessible with e.g., the WHOIS service. For most of the more than 290 country code top-level domains (ccTLDs), the domain registries maintain the WHOIS (Registrant, name servers, expiration dates, etc.) information. For instance, DENIC, Germany NIC, holds the DE domain data.

Domain name registrations need to be renewed at set time intervals, typically the time period for registration is 1 to 10 years. If the domain name registration is not renewed, the right to use that domain name also ends and usually that certain domain name is open for others to register.

In the solution of the disclosure, it can be checked whether DNS queries, e.g., from a computer, such as a local computer of a network, are trying to reach expired or unregistered domains. In the solution of the disclosure DNS (Domain Name System) queries and/or information relating to DNS queries is collected for example from the host, such as a computer and/or an endpoint. Failed queries are identified from the collected DNS queries and/or from information relating to DNS queries. Based on the collected information it's determined whether a domain related to the failed DNS query is related to an expired and/or unregistered domain, e.g., from a domain name related database. The DNS queries and/or information related to DNS queries can be collected from domain reputation queries, such as EPP-domain reputation queries, event flow information, such as EDR- and MDR-event flow, DNS logs, such as device DNS logs and/or network device level DNS logs, and/or network level capture.

If an expired and/or unregistered domain is found, an alert, such as a malware alert, can be created and/or sent for example to a threat detection or prevention service, such as an attack surface mapping service, an EDR-service, an MDR-service, an exposure management services. In one embodiment of the disclosure the expired and/or unregistered domain can be automatically registered e.g., to prevent anyone else from registering it and using it for malicious purposes.

The status of the domain registration (e.g., registered, unregistered and/or expired) can be checked e.g., from services and/or tools which track domain registrations. It's also possible to request this domain registering information from a domain registrar, such as Name.com, and e.g., then use their API to query for domain registration status.

In one embodiment of the disclosure the process which has generated the call to the unregistered and/or expired domain can be identified and this identification can be done e.g., by an EDR- or MDR-service. Also, past behavior of the identified process can be determined and/or examined, e.g., based on telemetry history of an EDR- or MDR-service. The identified process can be monitored for example by comparing the past behavior of the process to the current operation of the process, and if deviation between the past behavior and current behavior is observed, an alert, e.g., an indicator of compromise-alert, can be generated and/or sent.

The information collected with the solution of the disclosure can be used by an exposure management system and/or attack path mapping. Attack path mapping focuses on understanding potential attack pathways and security weaknesses by understanding the potential pathways that attackers could use to compromise an organization's systems and data. Attack path mapping can involve identifying and analyzing the various entry points, vulnerabilities, and attack vectors that attackers could exploit to achieve their objectives. The goal of attack path mapping is to gain insights into the organization's attack surface and identify potential weaknesses and security gaps that could be exploited by attackers.

In one embodiment of the disclosure the DNS queries relating to expired and/or unregistered domain, and/or the identified process which is generating calls to expired and/or unregistered domain is reported as an attack surface, e.g., to an attack surface mapping service or attack surface mapping system.

In one embodiment of the disclosure information relating to the identified process which is generating calls to expired and/or unregistered domain, and/or a host, such as a computer, generating the identified call are used by an exposure management service when carrying out an attack path simulation, e.g., by simulating code execution by the identified process. In one embodiment of the disclosure the attack path simulation can be configured to simulate a situation in which an attacker registers the domain and a DNS query to an expired and/or unregistered domain is directed to an attacker-controlled domain.

In one embodiment of the disclosure the DNS queries relating to expired and/or unregistered domain, and/or the identified process which is generating calls to expired and/or unregistered domain are used at least in part for determining risk score for a host, risk score for an attack path on which the host is and/or risk score for the organization relating to the host, e.g., by increasing the risk score.

In the solution of the disclosure the applications can be monitored, e.g., at the host, computer and/or at the backend, by tracking events created by the monitored application, such as created or changed files, accesses to registry, changes done to registry, created processes, created child processes, injection of processes in other processes, and/or by analyzing captured events to be malicious, e.g., by recognizing known patterns of file encryption, preventing malware detection by the application.

In the solution of the disclosure the applications can be monitored e.g., from MDR or EDR event telemetry event flow, for example either at the sensor of a node or computer or at the backend. In one embodiment of the disclosure, information about normal, i.e. usual and frequent, behaviour and/or operation of the application is collected from multiple hosts or computers of the computer network, such as a threat detection network. A behavioural digest can be built for all applications and services, e.g. that execute for longer time than a predefined duration, on the device. Vulnerability information for an application can be queried and received from a server, a service, a backend system, an external source and/or vulnerability management service, e.g. based on an identifier of the application. In one embodiment the solution of the disclosure can check in which hosts a certain application is installed. An application control policy can be created for at least part of the hosts or computers of the network or for each computer of the network. The application control policy can be e.g. such that it allows the network connections, file write destinations, and child process executions, other operations that have been previously done on said host by the application, and which e.g. blocks or alerts on every other action by the application. The end result can be a set of configurations that allow the vulnerable application to continue carrying out operations that it has been carrying out previously, but anything novel is restricted or blocked.

If a sandbox service is utilized, an application can be uploaded to a backend service, where it will be detonated in a virtual machine. The virtual machine and sandbox service can also be used at the local machine, e.g. a computer, an endpoint or host. The service will monitor the behaviour of the application in the virtual machine, and it can build a risk rating for the application. In one embodiment of the disclosure, virtualization or emulation, such as hardware virtualization, e.g. Hyper-V, software virtualization or emulation can be utilized. Virtual machine or emulator can execute a virtual copy of operating system on local machine or a server, such as a LAN server. In one embodiment a virtual machine or a software emulator can be started and/or initialized in response to starting a software application at a local machine and/or e.g. when an application carries out on action which is not allowed by the model of normal behavior of the application. The software application can be passed to the virtual machine or the software emulator. Application events and/or behavior is analyzed at the virtual machine or the software emulator to determine malicious behavior of the application. Based on the detected malicious behavior of the software application at the virtual machine or the software emulator, the local machine can be notified about the malicious behavior and the virtual machine.

A sandbox unit which can be utilized in the solution of the disclosure can in one embodiment of the disclosure be a group of components that enable tracing of system-wide behaviour of a given application in a contained manner by executing the application with restricted access and/or non-persistent access (changes made by the application may be rolled back). The unit can be responsible for quarantining the application, and when the application was already executed on the computer, also to revert the system changes e.g. based on the created backup. Likewise, the unit can also be responsible for performing the undo on any quarantine operations. If the malware analysis is done at a virtual machine, reverting the device and/or system settings and/or removal of detected malware may not be necessary.

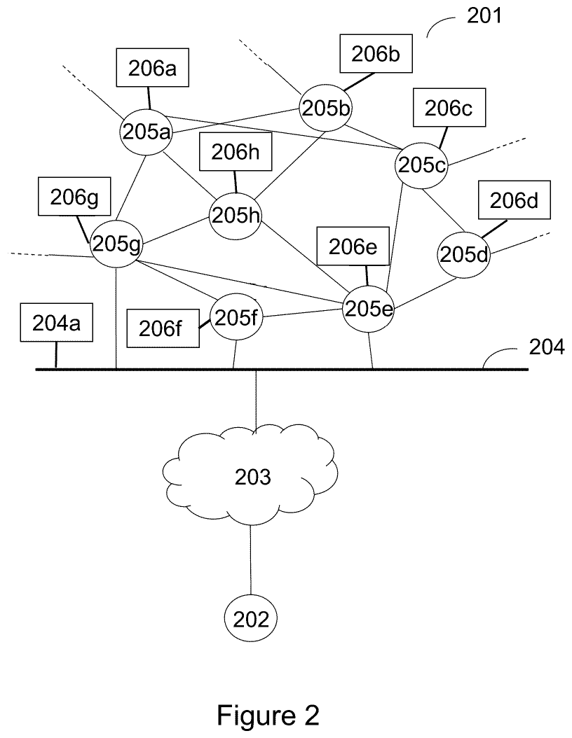

FIG. 2 presents schematically also an example network architecture of one embodiment of the disclosure in which the solution of the disclosure can be used. In FIG. 2 a part of a first local computer network 201 is schematically illustrated into which a computer system, for example an exposure management, EPP or an EDR system, has been installed. Also, any other computer system that is able to implement the embodiments of the disclosure can be used instead or in addition to the exposure management, EPP or EDR system used in this example. The first local computer network is connected to a security service network, in one embodiment a security backend system or server 202, through a network 203. The network can be similar as the network 103 in FIG. 1. The backend system or server 202 can be similar as the server 102 of FIG. 1. The backend system or server 202 can form a node on the security service computer network relative to the first local computer network. The security service computer network can be managed by a threat detection system provider and may be separated from the network 203 by a gateway or other interface (not shown) or other network elements appropriate for the backend 202. The first local computer network 201 may also be separated from the network 203 by a gateway 204 or other interface. Other network structures are also possible. In one embodiment of the disclosure the server can comprise a threat detection controller.

The first local computer network 201 may be formed of a plurality of interconnected network nodes 205a-205h, each representing an element in the first local computer network 201 such as a computer, smartphone, tablet, laptop, or other piece of network enabled hardware. In one embodiment of the disclosure the node is any device on the network but not a gateway. Each network node 205a-205h shown in the first local computer network can also represent an endpoint, e.g. an EDR endpoint and/or EPP endpoint, onto which an agent or a sensor 206a-206h, that may include a data collector or sensor, is installed. The network nodes 205a-205h can be similar as the computer 101 of FIG. 1. The agent or sensor may also be installed in some embodiments of the disclosure on any other element of the computer network, such as on the gateway or other interface. In the example of FIG. 2 a security agent module 204a has been installed on the gateway 204. In one embodiment of the disclosure the agents or sensors are the malware scanning agents or sensors. The agents or sensors, 206a-206h, 204a can collect various types of data at the nodes 205a-205h or gateway 204 including, for example, program or file hashes, files stored at the nodes 205a-205h, logs of network traffic, process logs, binaries or files carved from memory (e.g. DLL, EXE, or memory forensics artefacts), and/or logs from monitoring actions executed by programs or scripts running on the nodes 205a-205h or gateway 204 (e.g. TCP dumps). The agents or sensors, 206a-206h, 204a can carry out other tasks, e.g. collect DNS-query related information. The data collected may be stored in a database or similar model for information storage for further use and/or sent to for further analysis. Any kind of threat detection models may further be constructed at the backend/server 202, and/or at a second server and be stored in the database. The nodes 205a-205h and the server 202 typically comprise a hard drive, a processor, and RAM.

Any type of data which can assist in detecting and monitoring a security threat, such as a security breach or intrusion into the system and/or an attack path verification task, may be collected by the agents or sensors 206a-206h, 204a during their lifecycle and that the types of data which are observed and collected may be set according to rules defined by the threat detection system provider upon installation of the threat detection system and/or when distributing components of a threat detection model. In an embodiment, a suspicious or malicious event among the monitored events may be detected by one or more detection mechanisms used. In an embodiment, the detection mechanisms used to detect the suspicious or malicious event and/or to verify a step or portion of the attack path may comprise using a machine learning model, a scanning engine, a heuristic rule, a statistical anomaly detection, a fuzzy logic-based model, predetermined rules.

In an embodiment of the present disclosure, at least part of the agents or sensors 206a-206h may also have capabilities to make decisions on the types of data observed and collected themselves. For example, the agents or sensors 206a-206h, 204a may collect DNS-query related information and/or collect data about the behavior of programs running on an endpoint and can observe when new programs are started. Where suitable resources are available, the collected data may be stored permanently or temporarily by the agents or sensors 206a-206h, 204a at their respective network nodes or at a suitable storage location on the first local computer network 201 and/or sent further.

The agents or sensors 206a-206h, 204a can be set up such that they send information such as the data they have collected or send and receive instructions to/from the threat detection system backend 202 through the network 203, such as internet. This allows the threat detection system provider to remotely manage the system without having to maintain a constant human presence at the organization which administers the first local computer network 201.

In one embodiment of the disclosure, the agents or sensors 206a-206h, 204a can also be configured to establish an internal network, e.g. an internal swarm intelligence network, that comprises the agents or sensors of the plurality of interconnected network nodes 205a-205h of the local computer network 201. As the agents or sensors 206a-206h, 204a collect data related to the respective network nodes 205a-205h of each agent or sensor 206a-206h, 204a, they are further configured to share information that is based on the collected data in the established internal network. In one embodiment a swarm intelligence network is comprised of multiple semi-independent security nodes (security agent modules) which are capable of functioning on their own as well. Thus, the numbers of instances in a swarm intelligence network may well vary. There may also be more than one connected swarm intelligence networks in one local computer network, which collaborate with one another.

The agents or sensors 206a-206h, 204a and/or the backend system can be further configured to use the collected data and information received from the internal network for generating and adapting models related to the respective network node 205a-205h and/or its users.

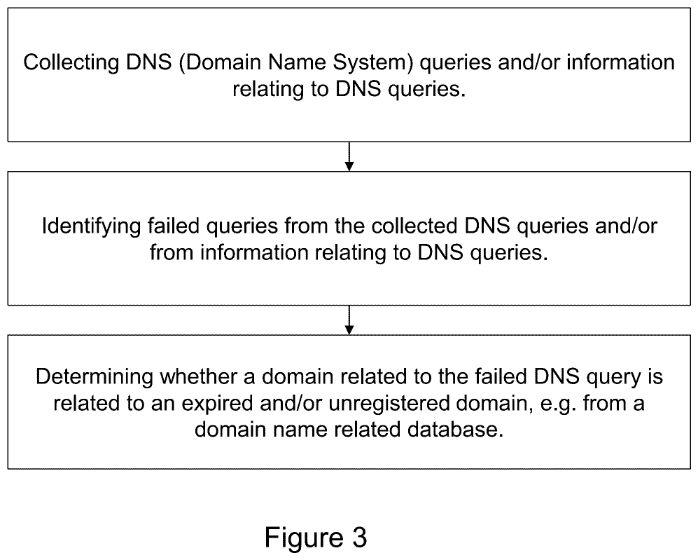

FIG. 3 presents an example method according to one embodiment of the disclosure. The example method comprises collecting DNS (Domain Name System) queries and/or information relating to DNS queries, identifying failed queries from the collected DNS queries and/or from information relating to DNS queries, and determining whether a domain related to the failed DNS query is related to an expired and/or unregistered domain, e.g. from a domain name related database.

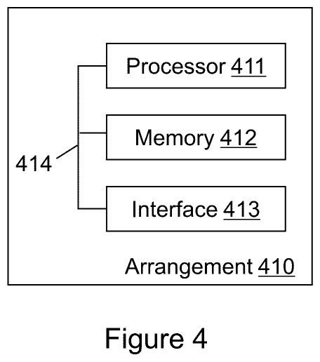

As presented in FIG. 4, an arrangement 410 or at least part of the arrangement, e.g. an endpoint and/or a server, according to exemplifying embodiments of the present disclosure may comprise at least one computer which comprises a processor 411 and at least one memory 412 (and possibly also at least one interface 413), which may be operationally connected or coupled, for example by a bus 414 or the like, respectively.

The processor 411 of the arrangement 410 is configured to read and execute computer program code stored in the memory 412. The processor may be represented by a CPU (Central Processing Unit), a MPU (Micro Processor Unit), etc., or a combination thereof. The memory 412 of the arrangement 410 is configured to store computer program code, such as respective programs, computer/processor-executable instructions, macros or applets, etc. or parts of them. Such computer program code, when executed by the processor 411, enables the arrangement 410 to operate in accordance with exemplifying embodiments of the present disclosure. The memory 412 may be represented by a RAM (Random Access Memory), a ROM (Read Only Memory), a hard disk, a secondary storage device, etc., or a combination of two or more of these. The interface 413 of the arrangement 410 is configured to interface with another arrangement and/or the user of the arrangement 410. That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

The arrangement 410 may, for example, represent a computer 101 or may represent a (part of a) server 102 in FIG. 1. The arrangement 410 may be configured to perform a procedure and/or exhibit a functionality as described in any one of FIGS. 1 to 3.

According to exemplifying embodiments of the present disclosure, the application to be monitored can be any electronic file, particularly encompassing any electronic file including a runnable/executable part, such as any kind of application file. Insofar, exemplifying embodiments of the present disclosure are applicable to any such electronic file, including for example a file of an Android Application Package (APK), a Portable Executable (PE), a Microsoft Soft Installer (MSI) or any other format capable of distributing and/or installing application software or middleware on a computer.

The data collected with the solution of the disclosure may be stored in a database or similar model for information storage for further use.

In an embodiment, further actions may be taken to secure the computer or the computer network if a malicious file, application or activity has been detected and/or DNS-request to unregistered and/or expired domains are made. Also actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious files may be removed or placed into quarantine, logs may be collected from network nodes, sets of command may be executed on network nodes, users of the one or more nodes may be warned that a threat or anomaly has been detected and that their workstation is under investigation, and/or a system update or software patch may be sent from the security backend to the nodes. In one embodiment of the disclosure one or more of these actions may be initiated automatically.

Next, some practical example of operation of a threat prevention and/or detection solution according to example embodiments of the disclosure will be described.

Deployment and distributing of the components of the threat detection or prevention system: In one embodiment of the disclosure, in which all agents may fundamentally have the same code base and/or ability to adapt to their role by activating different components in their modular architecture and replicate themselves, one would merely need to deploy one initial agent in a customer network with sufficient access rights, which would then discover servers and install copies of itself in the suitable locations and establish the internal communications network, e.g. an internal swarm communications network, as well as the backend update, reporting and communication channel. In addition, authentication and other required issues may need to be considered, and in first incarnations agents may be deployed on individual hosts.

Normal operation: The agents continuously monitor their environment and collect data, learning from what they see and build models, e.g. threat detection models and/or models of normal behavior of an application. These models may be shared across swarm nodes and used for learning, for example of users' behavior on one computer vs. others in the network. Additionally, abstract information may be sent to the backend in a privacy preserving way. The agents utilize the abovementioned learning models to be prepared also for knowing what is normal.

Encountering a known threat: The agents detecting either a known threat or an anomaly indicating a known threat may instantly alert other nodes (such as computers or servers) of the situation, also to prepare for threats that may deactivate them, and call for additional resources if needed (spin up new virtual agents or have them delivered from another host if there is risk of compromise). A known threat can be detected based on the behavior of a computer, a user and/or an application when comparing the detected behavior to the behavior model. If the agent already has the means for response, that action may be taken.

Encountering a novel threat: The agents, due to constantly learning what is normal and in a very granular manner due to their specificity with the data of their own nodes combined with the broader view of possible global, organization or user group level models, are also well equipped to detect novel threats. Their ability to interact with the users may be used to verify the threat, and if the threat is verified, take actions to contain it as well as build a new threat model that can be circulated, to other nodes, computers and/or servers. In some embodiments, the risk of the threat may be determined to be so great that autonomous containment actions may also be taken before awaiting a final decision. The degree of autonomous actions can always be adjusted as needed. The connectivity model also allows for the help of human experts to be called upon if needed.

Backend preparation: Constantly during operation, generated behavior models of the applications, users and/or information on events and/or threats can be abstracted and sent to the backend. This enables a backend “laboratory” to continue experimentation on more effective defense tools in a secure environment as well as provides further correlation and analysis of the data sent from the multitude of individual intelligent agents or sensors. Backend can also share threat detection models to the nodes.

As described above, the nature of the model used by the system (e.g. EDR or MDR) may be, or may incorporate elements, from one or more of the following: a neural network trained using a training data set, exact or heuristic rules (e.g. hardcoded logic), fuzzy logic based modelling, and statistical inference-based modelling. The model may be defined to take into account e.g. particular usage patterns of an application, a program, node, files, processes, connections, and dependencies between processes.

Although the disclosure has been described in terms of example embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be likewise incorporated, whether alone or in any appropriate combination with any other feature disclosed or illustrated herein. Lists and groups of examples provided in the description given above are not exhaustive unless otherwise explicitly stated.

1. A computer-implemented method of threat detection in a computer or computer network, wherein the method comprises:
collecting DNS (Domain Name System) queries or information relating to DNS queries;
identifying failed queries from the collected DNS queries or from information relating to DNS queries; and
determining whether a domain related to the failed DNS query is related to an expired or unregistered domain from a domain name related database.

2. The method according to claim 1, wherein the DNS queries or information related to DNS queries are collected at the computer by an agent at the computer.

3. The method according to claim 1, wherein the DNS queries or information related to DNS queries are collected from domain reputation queries, event flow information, DNS logs, or network level capture.

4. The method according to claim 1, wherein, if at least one expired or unregistered domain is found, the method further comprises generating an alert and sending the alert to a threat detection or prevention service.

5. The method according to claim 4, wherein the alert is a malware alert.

6. The method according to claim 4, wherein the threat detection or prevention service is an attack surface mapping service, an EDR-service, an MDR-service, or an exposure management service.

7. The method according to claim 1, wherein the method further comprises identifying a process which has generated a call to the unregistered or expired domain.

8. The method according to claim 7, wherein the method further comprises determining past behavior of the identified process based on telemetry history of an EDR-service or MDR-service.

9. The method according to claim 7, wherein the method further comprises:
monitoring the identified process by comparing the past behavior of the process to the current operation of the process, and
if deviation between the past behavior and current behavior is observed, generating an indicator of compromise-alert and sending the indicator of compromise-alert.

10. The method according to claim 1, wherein the DNS queries relating to expired or unregistered domain is reported as an attack surface to an attack surface mapping service.

11. The method according to claim 7, wherein the identified process which is generating calls to expired or unregistered domain is reported as an attack surface to an attack surface mapping service.

12. The method according to claim 7, wherein information relating to the identified process which is generating calls to expired or unregistered domain is used by an exposure management service when carrying out an attack path simulation by simulating code execution by the identified process.

13. The method according to claim 12, wherein information relating to a host generating the identified call is used by the exposure management service when carrying out the attack path simulation.

14. The method according to claim 12, wherein the attack path simulation is configured to simulate a situation in which an attacker registers the domain and a DNS query to an expired or unregistered domain is directed to an attacker-controlled domain.

15. The method according to claim 1, wherein the DNS queries relating to expired or unregistered domain are used at least in part for determining a risk score for a host, a risk score for an attack path on which the host is located, or a risk score for an organization relating to the host by increasing the risk score.

16. The method according to claim 7, wherein the identified process which is generating calls to expired or unregistered domain is used at least in part for determining a risk score for a host, a risk score for an attack path on which the host is located, or a risk score for an organization relating to the host by increasing the risk score.

17. The method according to claim 1, wherein the method further comprises automatically registering the expired or unregistered domain.

18. A system for threat detection in a computer or computer network, comprising:
at least one hardware processor; and
memory having program instructions stored thereon that, when executed by the at least one hardware processor, direct the at least one hardware processor to:
collect DNS (Domain Name System) queries or information relating to DNS queries;
identify failed queries from the collected DNS queries or from information relating to DNS queries; and
determine whether a domain related to the failed DNS query is related to an expired or unregistered domain.

19. The system according to claim 18, wherein the at least one hardware processor is further directed to identify a process which has generated a call to the unregistered or expired domain, and determine past behavior of the identified process based on telemetry history of an EDR-service or MDR-service.

20. A non-transitory computer-readable medium storing a computer program executable by at least one hardware processor that, when executed, directs the at least one hardware processor to:
collect DNS (Domain Name System) queries or information relating to DNS queries;
identify failed queries from the collected DNS queries or from information relating to DNS queries; and
determine whether a domain related to the failed DNS query is related to an expired or unregistered domain.
